(19) United States
(12) Patent Application Publication
(10) Pub. No.: US 2015/0308567 A1
(43) Pub. Date: Oct. 29, 2015

(54) GEAR SHIFTER ARRANGEMENT

(71) Applicant: Deere & Company, Moline, IL (US)

(72) Inventor: Pravin Jadhav, Pune (IN)

(21) Appl. No.: 14/695,511

(22) Filed: Apr. 24, 2015

(30) Foreign Application Priority Data
Apr. 28, 2014 (IN) 1478/MUM/2014

(51) Int. Cl. F16H 61/26; F16H 63/30

(52) U.S. Cl. CPC F16H 61/26; F16H 63/3013

(57) ABSTRACT

The present invention discloses a gear shifter arrangement configured within a transmission case to switch transmission of input torque from an input shaft to an output shaft through respective gears associated therewith. An idler gear (20) is rotatably supported on an idler shaft (18) which is fixedly mounted on the transmission case. At least one shifter fork, having a hub (29) with a pair of radially extending gripping elements (28), is slidably mounted on the idler shaft (18). The shifter fork is adapted to be slidably displaced on the idler shaft (18) by a linkage mechanism cooperating with a gear actuator.

### FIELD OF THE INVENTION

The present invention relates to shifting of gears within a transmission case. Particularly the present invention relates to arrangement of a shifter fork within the transmission case.

### BACKGROUND OF THE INVENTION

A vehicle is powered by the torque transmitted from the engine to a driving axle of the vehicle via a transmission unit. The transmission unit receives torque from the engine through an input shaft. The torque from the input shaft is transmitted to the output shaft via a gear arrangement located within the transmission unit. Each of the input shafts includes at least one gear required to be engaged with at least one gear of the output shaft for transmission of torque from the input shaft to the output shaft. The speed of rotation of the output shaft depends on the gear ratio of the meshing gears of the input shaft and the output shaft. The torque from the output shaft transmits torque to the driving axle of a vehicle.

The engagement and disengagement of the gears of the input shaft and the output shaft is facilitated with the help of gear shifters, which presently are mounted on discrete shift rails. The shift rails, mounted within the transmission unit, functionally cooperate with a gear lever operated by the operator of a vehicle. The increase in the number of shift rails leads to bulky transmission units which causes an increase in cost of transmission unit and also increases the maintenance cost of the transmission unit.

Thus, there is a need for a gear shifter arrangement that enables overcoming the drawbacks of the presently available systems for shifting gears.

### SUMMARY OF THE INVENTION

The present invention is directed towards gear shifter arrangement configured within a transmission case so as to enable optimal utilization of the length of an idler shaft which is primarily intended towards supporting idler gear, thereby realizing a compact transmission unit. The realization of the present invention is envisaged to overcome the drawbacks of conventional transmission units which are bulky and involves at least one shift rail for mounting of shifter forks. The present invention eliminates the necessity of providing for the shift rails.

The problem of conventional transmission units are obviated by the present invention by mounting the idler shaft on the transmission case so as to be fixed thereon. An idler gear is rotatably supported on the idler shaft via bearings. The shifter forks are displaceably mounted on the idler shaft, thereby eliminating the requirement for providing discrete shift rails for each shifter fork. Each shifter fork includes a hub and a pair of gripping elements, radially extending from the hub.

The shifter fork is mounted on the idler shaft through the hub. A positive clearance is maintained between the hub and the idler shaft which enables displacing the shifter fork on the idler shaft. Alternatively, the hub is displaceable on the idler shaft through mounting arrangements selected from the group consisting of matching serrations and a tongue and groove arrangement. At least one locating arrangement is provided to enable controlled displacement of the shifter fork on the idler shaft. The shifter fork is associated with a shifter link through a link engaging portion defined on the hub of the shifter fork. The link engaging portion is defined on the hub as a projection with a notch. In an alternative embodiment, the link engaging portion is defined as a groove on the hub. The link engaging portion is configured to embrace one end of the shifter link while the other end of the shifter link is engaged with a linkage mechanism. Each of the shifter forks are displaced by the linkage mechanism functionally connecting the shifter forks to a gear actuator. The gear actuator is operable by actuation means, such as, manual actuation, electronic actuation, hydraulic actuation or pneumatic actuation.

Various features, aspects and advantages of the present invention will be apparent from the following detailed description of the invention when read in conjunction with the accompanying drawings wherein like numerals represent like components.

### BRIEF DESCRIPTION OF THE ACCOMPANYING DRAWINGS

The gear shifter arrangement of the present invention will now be described with respect to the accompanying drawings wherein:

FIG. 1 illustrates a perspective view of the gear shifter arrangement connected to the gear lever;

FIG. 2 illustrates a portion A of FIG. 1, elucidating the transmission unit in accordance with the present invention; and

FIG. 3 illustrates a shifter fork mounted on an idler shaft supporting an idler gear.

### DETAILED DESCRIPTION OF A PREFERRED EMBODIMENT

A transmission case of a vehicle houses a transmission unit which enables transmission of torque from an input shaft to an output shaft via a pair of meshing gears; wherein one of the meshing gears is mounted on the input shaft while the other meshing gear is mounted on the output shaft. The input shaft receives input torque from the engine of the vehicle, while the output shaft receives input torque and transmits output torque for displacing the wheels of the vehicle. The conversion of the input torque to the output torque depends on the gear ratio of the meshing gears which is variable depending on the requisite output torque. The gear ratio is varied by varying the gears on the output shaft to be meshed with the gears on the input shaft. The shifting of the gears on the output shaft to mesh with the gears on the input shaft is facilitated by at least one shifter fork which is displaceable corresponding to the displacement of the gear lever by the operator of the vehicle. In a conventionally transmission unit, a shifter fork is mounted on an associated shift rail functionally engaged with the gear lever. Further, a conventional transmission unit includes an idler gear fixedly mounted on an idler shaft rotatably supported on the transmission case. The idler shaft is configured to rotate with the rotation of the idler gear. The idler gear is provided to reverse the normal direction of rotation of the output shaft so that the vehicle is maneuverable in a desired direction.

The present invention stems from the observation that a conventional transmission unit is bulky since they are required to accommodate at least one additional shift rail and associated linkages. This further leads to an increase in the cost involved in manufacturing as well as maintenance.

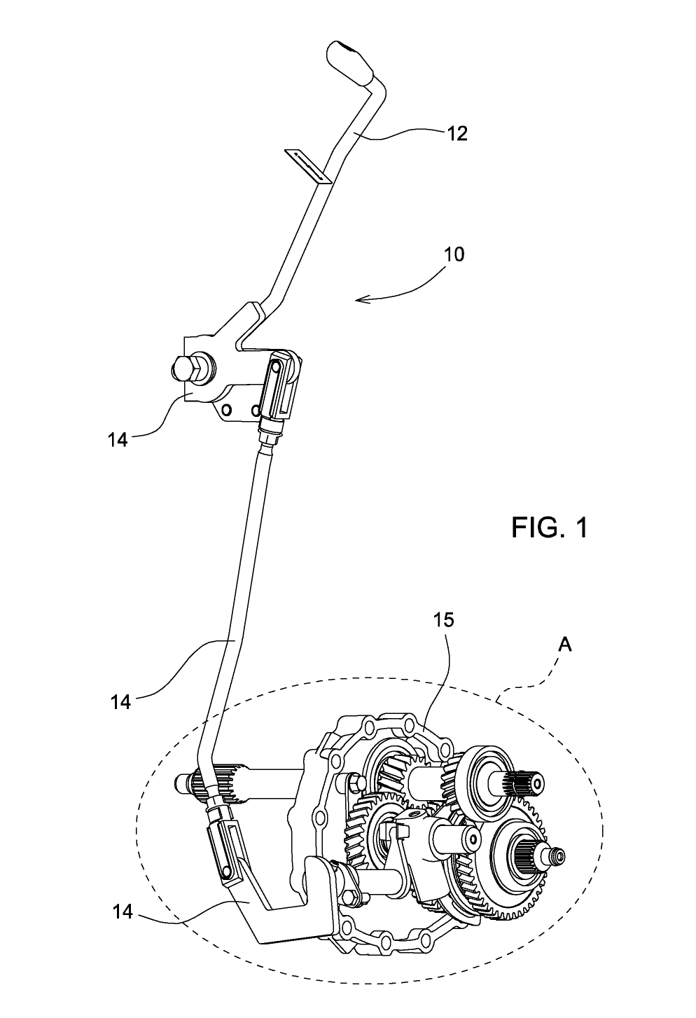

The present invention envisages a transmission unit capable of obviating the shortcomings of a conventional transmission unit. The transmission unit of the present invention helps at eliminating the shift rails while enabling efficient shifting of the gears. FIG. 1 illustrates the transmission system, referenced by the numeral 10. The transmission system (10) includes a transmission unit (A), in accordance with the present invention, mounted within a transmission case (15) and functionally cooperating with the gear lever (12) via a linkage mechanism having a plurality of connecting linkages (14).

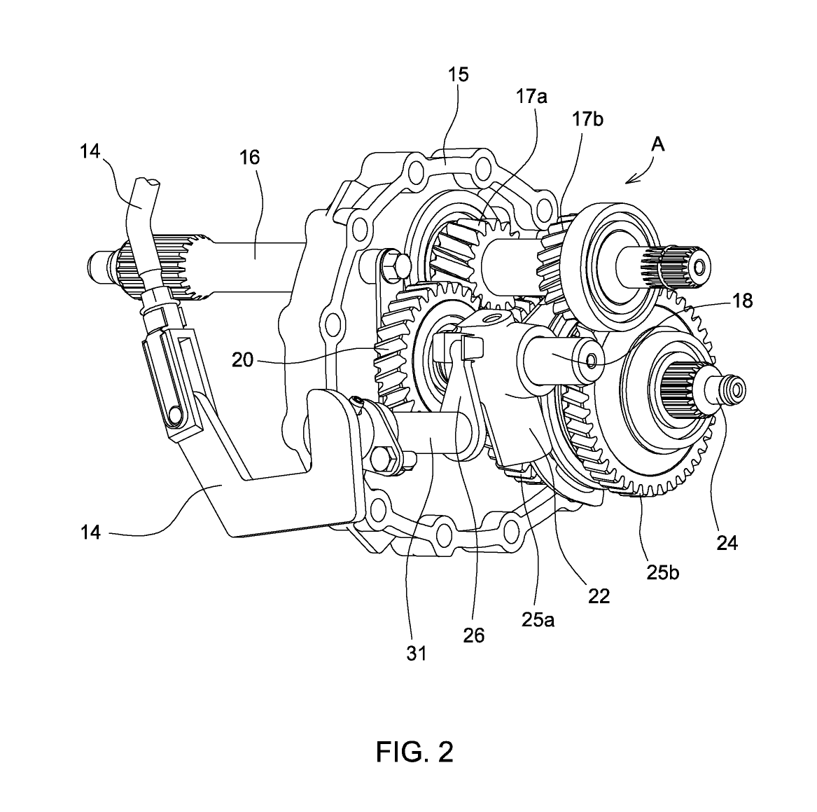

The transmission unit (A), particularly illustrated in FIG. 2, like conventional transmission units, includes an input shaft (16) having input gears (17a and 17b) rotatably engaged thereon, an output shaft (24) having output gears (25a and 25b) rotatably engaged thereon and an idler shaft (18) supporting an idler gear (20) rotatably mounted thereon. The idler shaft (18) is substantially parallel to the input shaft (16).

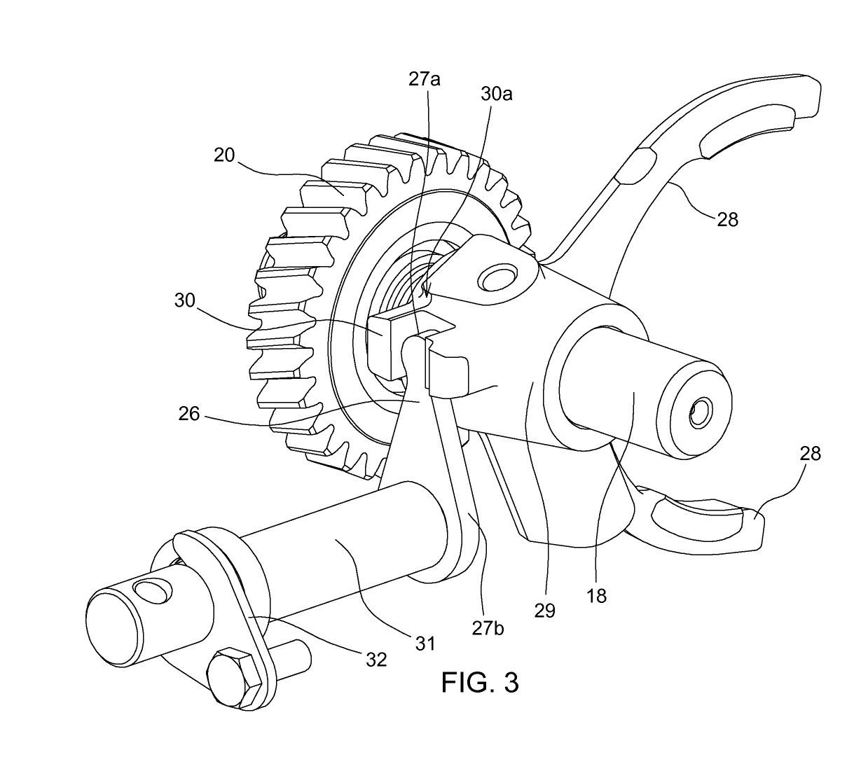

The idler shaft (18) is fixedly mounted on the transmission case (15) while the idler gear (20) is rotatably mounted thereon by means of bearings (not shown). The present invention envisages optimally utilizing the length of the idler shaft (18). In accordance with the present invention, at least one shifter fork (22) is slidably mounted on the idler shaft (18), as illustrated in FIG. 3. Each of the shifter forks (22) includes a pair of gripping elements (28) and a hub (29). The pair of gripping elements (28) is integral with the hub (29) and radially extends therefrom. The shifter fork (22) is mounted on the idler shaft (18) through the hub (29) such that a positive clearance is maintained therebetween. Alternatively, the hub (29) is mounted on the idler shaft (18) through mounting arrangements (not shown), such as, matching serrations or a tongue and groove arrangement. At least one locating arrangement (not shown) is provided to enable controlled displacement of the shifter fork (22) on the idler shaft (18).

The shifter fork (22) is associated with a shifter collar (23). The shifter fork (22) is linearly displaced on the idler shaft (18) by displacement of the gear lever (12). The displacement of the gear lever (12) is translated into displacement of the shifter fork (22) by virtue of the connecting linkages (14), such that, the shifter collar (23) engages the input shaft (16) and the output shaft (24) via the input gears (17a and 17b) and the output gears (25a and 25b). This is facilitated by engagement between either the input gear (17a) and the output gear (25a) or the input gear (17b) and the output gear (25b). The engagement between the input gear (17a) and the output gear (25a) is achieved via the idler gear (20).

The shifter fork (22) is functionally engaged with the connecting linkages (14) via a shifter link (26). The shifter link (26) is elongated in shape and has a first end (27a) and a second end (27b). The linkage mechanism is operated by an actuation means. Although the present invention will henceforth be described as using manual actuation means, such as, gear lever (12), as indicted in FIG. 1, however a person ordinarily skilled in the art would appreciate that the actuation means also includes an electronic actuation means, a hydraulic actuation means or a pneumatic actuation means. The linkage mechanism is supported on the transmission case (15).

A link engaging portion (30), as illustrated in FIG. 3, is defined on the hub (29) of the shifter fork (22), such that, the link engaging portion (30) is diagonally opposite the gripping elements (28). The link engaging portion (30) defines a projected notch (30a). The first end (27a) of the shifter link (26) is displaceably engaged within the projected notch (30a). Thus, the link engaging portion (30) is configured to embrace the first end (27a) of the shifter link (26). The second end (27b) of the shifter link (26) cooperates with the connecting linkages (14) via a connecting rod (31). Alternatively, the link engaging portion (30) is provided as a notch (not shown) defined on the surface of the hub (29).

When the gear lever (12) is actuated, the connecting linkages (14) are displaced so as to cause the first end (27a) of the shifter link (26) to be angularly displaced within the projected notch (30a), illustrated in FIG. 3. The angular displacement of the shifter link (26) exerts a push/pull force on the shifter fork (22) so as to linearly displace the shifter fork (22) along the longitudinal axis of the idler shaft (18). This causes engagement of a shifter collar (23) with the output gear (25a or 25b). The linear displacement of the shifter fork (22) on the idler shaft (18) causes the shifter collar (23) to be engaged with one of the output gears (25a or 25b), thereby facilitating engagement of the output gear (25a or 25b) with the input gear (17a or 17b). The meshing configuration of the input gear (17a or 17b) and the output gear (25a or 25b) enables transmission of torque from the input shaft (16) to the output shaft (24).

Thus, the gear shifter arrangement (A) of the present invention enables effectively utilizing the idler shaft (18) thereby enabling elimination of using discrete shift rails for mounting of a plurality of shifter fork (22). This enables in realizing a transmission case which is compact and cost effective.

The gear shifter arrangement of the present invention has several technical advancements, including but not limited to the realization of:
reducing the space required by the transmission unit of a vehicle;
minimizing the overall weight of the transmission unit of a vehicle;
minimizing the number of parts involved in shifting of gears; and
reducing the cost of maintenance of the transmission unit.

While the foregoing specification has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure which comes within known or customary practice in the art to which this invention pertains.

We claim:

1. A gear shifter arrangement configured within a transmission case to switch transmission of input torque from an input gear, supported on an input shaft, to at least one output shaft through at least one associated output gear supported thereon, corresponding to a requisite output torque, comprising:
an idler shaft fixedly mounted on said transmission case, said idler shaft adapted to be parallel to at least one of said input shaft;
an idler gear rotatably supported on said idler shaft;
at least one shifter fork slidably mounted on said idler shaft via a hub, said shifter fork adapted to selectively engage with one of the associated output gear via a pair of gripping elements, radially extending from said hub;
a shifter link functionally engaging with said hub to enable slidably displacing said shifter fork on said idler shaft along a longitudinal axis thereof; and
a linkage mechanism adapted to angularly displace said shifter link to slidably displace said shifter fork, wherein said linkage mechanism is adapted to be supported on the transmission case.

2. The gear shifter arrangement of claim 1, wherein said idler gear is rotatably supported on said idler shaft through at least one bearing.

3. The gear shifter arrangement of claim 1, wherein a positive clearance is provided between said hub and said idler shaft to enable displacement of said shifter fork on said idler shaft, and said shifter fork is controllably displaceable on said idler shaft by at least one locating arrangement.

4. The gear shifter arrangement of claim 1, wherein said hub is displaceable on said idler shaft through mounting arrangements selected from the group consisting of splines, a tongue and groove arrangement, and a spring loaded arrangement.

5. The gear shifter arrangement of claim 1, further comprising a link engaging portion on the hub, substantially opposite said gripping elements and diagonally away from said gripping elements.

6. The gear shifter arrangement of claim 5, wherein said link engaging portion is configured to embrace said first end of said shifter link in said displaceably engaged configuration.

7. The gear shifter arrangement of claim 5, wherein said link engaging portion is defined on a projection with a notch.

8. The gear shifter arrangement of claim 5, wherein said link engaging portion is defined as a groove on said hub.

9. The gear shifter arrangement of claim 1, wherein said shifter link is an elongated element having a first end and a second end, distal from said first end, and wherein said first end is adapted to be displaceably engaged with said link engaging portion, and said second end is adapted to cooperate with said linkage mechanism.

10. The gear shifter arrangement of claim 1, wherein said linkage mechanism functionally cooperates with a gear actuator, said gear actuator being adapted to be operated by actuation means selected from the group consisting of manual actuation, electronic actuation, hydraulic actuation and pneumatic actuation.
